(19) United States
(12) Patent Application Publication
(10) Pub. No.: US 2017/0011631 A1
(43) Pub. Date: Jan. 12, 2017

(54) DRIVER-INDEPENDENT TRANSFER OF A MOTOR VEHICLE

(71) Applicant: Robert Bosch GmbH, Stuttgart (DE)

(72) Inventors: Stefan Nordbruch, Kornwestheim (DE); Jan Rexilius, Hannover (DE); Gregor Blott, Salzgitter (DE); Jan Karl Warzelhan, Bad Salzdetfurth Ot Heinde (DE)

(21) Appl. No.: 15/198,970

(22) Filed: Jun. 30, 2016

(30) Foreign Application Priority Data
Jul. 7, 2015 (DE) 102015212689.7

(51) Int. Cl. G08G 1/14; G05D 1/02

(52) U.S. Cl. CPC G08G 1/143; G05D 1/0212; G05D 1/0276

(57) ABSTRACT

A motor vehicle is to be transferred over a segment between a transfer point and a parking space of a parking facility. A method includes steps of detecting a motor vehicle that is to be parked in a parking space, determining unoccupied parking spaces in the parking facility, determining a traffic volume in the parking facility, and selecting one of the unoccupied parking spaces in such a way that the traffic volume on a segment between the transfer point and the selected parking space is preferably minimized. Subsequently, the motor vehicle may be guided driver-independently from the transfer point to the selected parking space.

### CROSS REFERENCE

The present application claims the benefit under 35 U.S.C. §119 of German Patent Application No. DE 102015212689.7 filed on Jul. 7, 2015, which is expressly incorporated herein by reference in its entirety.

### FIELD

The present invention relates to a driver-independent parking system. In particular, the present invention relates to assigning an unoccupied parking space to a motor vehicle.

### BACKGROUND INFORMATION

A parking system includes a parking facility having multiple parking spaces for parking motor vehicles; a motor vehicle may be steered automatically in a parking system over a segment between a drop-off place and one of the parking spaces in the parking facility. Such a procedure is known as Automated Valet Parking (AVP). If a motor vehicle is to be parked in the parking facility, it is sufficient for the driver to take the motor vehicle to the drop-off place and to leave it there. The motor vehicle then moves automatically to one of the parking spaces assigned to it by a management system, for example. If the motor vehicle is to be later retrieved, it may move automatically in the opposite direction from the parking space to the drop-off place, where the driver enters and drives the motor vehicle himself outside the parking facility as usual.

The functions of a management system for the parking facility include, among others, the selection of an unoccupied parking space for the motor vehicle. A segment between the transfer point and the parking space may then be determined and the motor vehicle may be guided over this segment. In different specific embodiments, parts of the segment determination and guidance may take place alternatively by the motor vehicle or by a control device of the parking facility.

Driving the motor vehicle on the segment is a complex procedure, which may be made even more difficult by a person or another motor vehicle moving in the parking facility.

Great Britain Patent No. GB 2 364 155 A relates to a method for finding an unoccupied parking space in a partially occupied parking garage. A parking space becoming unoccupied is determined by evaluating a parking ticket of a motor vehicle leaving the parking garage.

An object of the present invention is to provide a method for improved driver-independent transfer of a motor vehicle in a parking facility.

### SUMMARY

A motor vehicle is to be moved independently of the driver over a segment between a transfer point and a parking space of a parking facility. A procedure includes steps of detecting a motor vehicle that is to be parked in a parking space, determining unoccupied parking spaces in the parking facility, determining any traffic volume occurring in the parking facility, and selecting one of the unoccupied parking spaces in such a way that the traffic volume on a segment between the transfer point and the selected parking space is minimized. The motor vehicle may then be guided from the transfer point to the selected parking space independently of the driver.

On the one hand, by selecting the parking space on the basis of traffic volume in the area of the parking facility, the guidance of the motor vehicle to be parked may be simplified. On the other hand, the traffic volume in the parking facility may be better balanced, i.e., uniformly distributed, so that overall simpler and safer walking or driving in the parking facility is possible.

The traffic volume is preferably determined on the basis of an actually occurring or planned transfer of another motor vehicle. In particular, if this is another driver-independent transfer, reliable information about the type, place, and duration of the movements of the other motor vehicle may be easily obtained. The traffic volume may thus be determined with a high degree of accuracy.

In another specific embodiment, the traffic volume is determined on the basis of scanning a traffic area located between the transfer point and an unoccupied parking space. In particular, a person moving in the parking facility may thus be better taken into account. A motor vehicle driven by a driver may also be better taken into account.

In particular, a trajectory of an object on the traffic area may be determined and the traffic volume may be predicted on the basis of the trajectory. The traffic volume may thus be determined for a point in time when the motor vehicle to be parked will be foreseeably moved in the parking facility.

The traffic volume may also be determined on the basis of a reservation of a parking space. For example, a remaining parking time, which indicates when the parking space is vacated by another motor vehicle, may be taken into account. A movement of the other motor vehicle may thus be better anticipated.

A computer program product includes program code means for carrying out the above-described procedure when the computer program product runs on a processing device or is stored on a computer-readable data carrier.

A device for driver-independent control of a transfer of a motor vehicle over a segment between a transfer point and a parking space of a parking facility includes a detection device for a motor vehicle, which is to be parked in a parking space, a first determining device for determining unoccupied parking spaces in the parking facility, a second determining device for determining a traffic volume in the parking facility, and a processing device for selecting one of the unoccupied parking spaces in such a way that the traffic volume on a segment between the transfer point and the selected parking space is minimized. In a further specific embodiment, the device is also designed for assisting or controlling the transfer of the motor vehicle on the segment.

In particular, the device may be designed to be integrated into another device, which carries out a management or control function in relation to the parking facility.

The first determining device may include a vehicle sensor for determining an occupancy state of a parking space. In another specific embodiment, a vehicle sensor is assigned to a certain number of parking spaces of the parking facility. Alternatively or additionally, a sensor for scanning a traffic area located between a parking space and the transfer point may be provided.

### BRIEF DESCRIPTION OF THE DRAWING

The present invention is now described with reference to the figure.

FIG. 1 shows a parking facility equipped for driver-independent parking.

### DETAILED DESCRIPTION OF EXAMPLE EMBODIMENTS

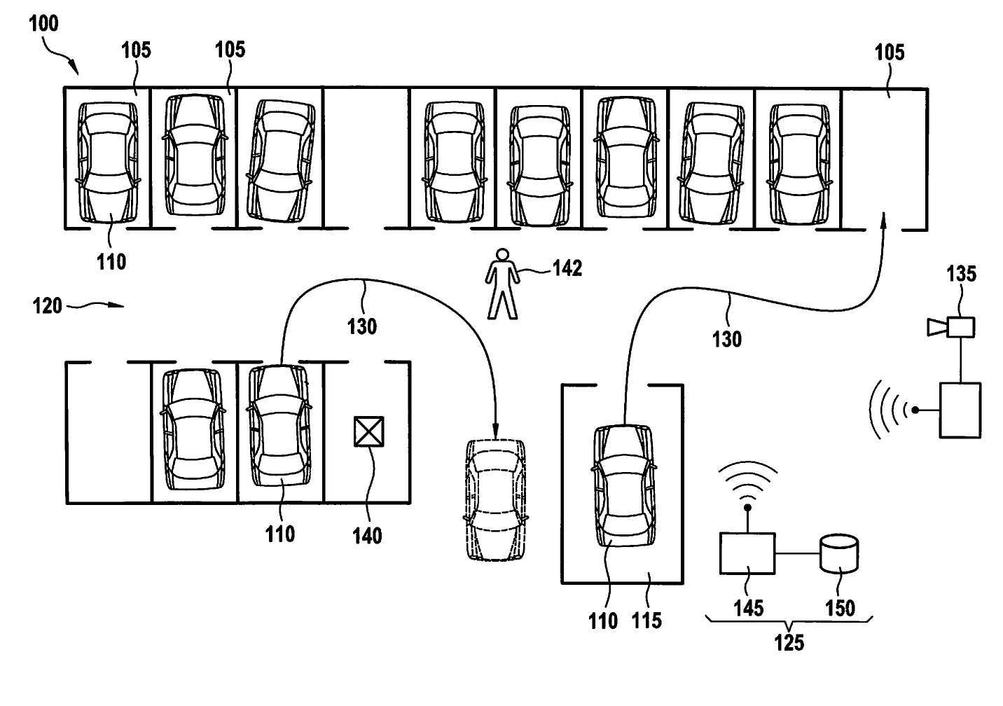

FIG. 1 shows a parking facility 100, which is equipped for Automated Valet Parking. Parking facility 100 may be part of a parking garage or an underground garage or located outdoors. Parking facility 100 includes multiple parking spaces 105, each one for parking a motor vehicle 110, a transfer point 115, and a traffic area 120, which is located between parking space 105 and transfer point 115 or between multiple parking spaces 105. Furthermore, a control device 125 is provided.

If a motor vehicle 110 is to be parked in parking facility 100, it is first taken by a driver to transfer point 115, where the driver may leave motor vehicle 110. Control device 125 then selects an unoccupied parking space 105 and also preferably determines a segment 130, which leads over traffic area 120 from transfer point 115 to selected parking space 105. In one specific embodiment, parking space 105 may be accepted or rejected by a driver of motor vehicle 110, so that an alternative parking space 105 may be selected.

If parking space 105 has been determined, the motor vehicle may be guided over segment 130 to selected parking space 105 and parked there. As the case may be, a parking procedure of motor vehicle 110 in parking space 105 is also controlled. Motor vehicle 110 is guided over segment 130 by motor vehicle 110, by control device 125, or by both together. Data may be exchanged between motor vehicle 110 and control device 125, for example, using a wireless transmission method such as WALN, Bluetooth, or mobile radio. In one specific embodiment, motor vehicle 110 is monitored in the sector of traffic area 120, for example, with the aid of a sensor 135, which may include, in particular, a camera, a photoelectric barrier, an ultrasound sensor, an inductive loop, a radar sensor, or a LIDAR sensor. Sensor 135 may be connected to control device 125 for data exchange using wireless, wire-bound, or a combined technology.

Customarily, additional traffic takes place while motor vehicle 110 is guided over segment 130 on traffic area 120. For example, another motor vehicle 110 may be in motion driver-driven or automatically driven on another segment 130 on traffic area 120, or another motor vehicle 110 may be entering or leaving the parking space. A person 142 may be moving on traffic area 120; for example, person 142 may be a driver of a motor vehicle 110, which is parked in one of parking spaces 105.

Customarily, different traffic volumes are occurring in different areas of parking facility 100, a high traffic volume representing a large number of vehicles or persons moving per unit of time, and a low traffic volume representing a small number of vehicles or persons moving per unit of time. The higher the traffic volume in an area of parking facility 100, the more difficult it is to drive motor vehicle 110 in this area.

In accordance with an example embodiment of the present invention, when selecting an unoccupied parking space 105 for a motor vehicle 110 to be parked, attention is paid to preferably avoid a segment between motor vehicle 110 and selected parking space 105 having high traffic volume areas.

The traffic volume may be determined by different methods, which may be combined with each other. It is generally preferred that the traffic volume is determined for a future point in time, when motor vehicle 110 to be parked will foreseeably pass through an area in question of parking facility 100, for which the traffic volume is being determined. To determine the traffic volume, an instantaneous or imminent movement of another motor vehicle 110 to a reserved parking space 105 or from a parking space 105 whose reservation has expired may be used. In particular, when the movement of the other motor vehicle 110 in the parking facility is assisted by control device 125, for example, because it is another AVP procedure, the movement of the other motor vehicle 110 may be reliably predicted.

In another specific embodiment, objects in traffic area 120 are detected with the aid of sensor 135. This is helpful in particular, for person 142. Preferably, trajectories are determined for detected objects 110, 142 on the basis of multiple scans, which allow interpolation into the future and thus determination of a likely impending traffic volume.

In order to determine an unoccupied parking space, the existing parking spaces 105 may be scanned with the aid of sensor 135, or multiple dedicated parking facility sensors 140 provided for this purpose may be scanned. In one specific embodiment, a parking facility sensor 140, which may be situated above or below a space provided for a motor vehicle 110, is assigned to each parking space 105. Any method may be used for determining whether or not a motor vehicle 110 is in parking space 105, for example, a capacitive sensor, a magnetic sensor, an optical sensor, an infrared sensor, a radar or LIDAR sensor, or any other sensor. In yet another specific embodiment, a parking space 105 may also be reserved, the reservations being scannable or manageable by control device 125. A reserved parking space 105 may be considered occupied.

In another specific embodiment, control device 125 controls further aspects of the parking operation in parking facility 100, for example, invoicing of a parking space fee. The control device preferably includes a processing device 145 and also preferably a memory 150 for storing information about parking space 105.

Control device 125 is configured to determine, on the basis of the determined unoccupied parking spaces 105, which one to assign to motor vehicle 110 to be parked at transfer point 115. It is then attempted to select a parking space 105 that maybe easily approached automatically, i.e., driver-independently. If a predetermined parking space 105 is reserved for motor vehicle 110 to be parked, it may be checked whether reserved parking space 105 is actually unoccupied or another parking space 105 must be selected.

For this purpose, in one specific embodiment, parking facility 100 or traffic area 120 is divided into lots, for each of which a traffic volume is determined. The lots are preferably adjacent to each other and may be rectangular or hexagonal, for example. Parking space 105 for motor vehicle 110 is then determined in such a way that segment 130 to parking space 105 passes through as few lots as possible whose traffic volume is greater than a predetermined threshold value. In another specific embodiment, the traffic volume of all lots through which segment 130 passes may be added up or integrated to a characteristic number, parking space 105 being selected in such a way that the characteristic number of segment 130 is preferably minimized. The two methods may also be combined. In all variants it is also possible to vary segment 130, for example, by using not the shortest route, but the one optimized regarding traffic volume.

On the basis of the determined traffic volume and unoccupied parking spaces 105, a parking space 105 is preferably selected that is optimal regarding automatic guidance of motor vehicle 110 to parking space 105. Automatic guidance of motor vehicle 105 is thus facilitated.

What is claimed is:

1. A method for driver-independent transfer of a motor vehicle over a segment between a transfer point and a parking space of a parking facility, the method comprising:
detecting a motor vehicle that is to be parked in a parking space;
determining unoccupied parking spaces in the parking facility;
determining a traffic volume in the parking facility; and
selecting one of the unoccupied parking spaces in such a way that the traffic volume on a segment between the transfer point and the selected parking space is minimized.

2. The method as recited in claim 1, wherein the traffic volume is determined on the basis of an ongoing transfer of another motor vehicle.

3. The method as recited in claim 1, wherein the traffic volume is determined on the basis of a planned transfer of another motor vehicle.

4. The method as recited in claim 1, wherein the traffic volume is determined on the basis of scanning a traffic area located between the transfer point and an unoccupied parking space.

5. The method as recited in claim 4, wherein a trajectory of an object on the traffic area is determined and the traffic volume is predicted on the basis of the trajectory.

6. The method as recited in claim 1, wherein the traffic volume is determined on the basis of a reservation of a parking space.

7. A non-transitory computer-readable data carrier storing a computer program code for driver-independent transfer of a motor vehicle over a segment between a transfer point and a parking space of a parking facility, the program code, when executed by a processing device, causing the processing device to perform:
detecting a motor vehicle that is to be parked in a parking space;
determining unoccupied parking spaces in the parking facility;
determining a traffic volume in the parking facility; and
selecting one of the unoccupied parking spaces in such a way that the traffic volume on a segment between the transfer point and the selected parking space is minimized.

8. A device for driver-independent control of a transfer of a motor vehicle over a segment between a transfer point and a parking space of a parking facility, the device comprising:
a detecting device for a motor vehicle that is to be parked in a parking space;
a first determining device for determining unoccupied parking spaces in the parking facility;
a second determining device for determining a traffic volume in the parking facility; and
a processing device for selecting one of the unoccupied parking spaces in such a way that the traffic volume on a segment between the transfer point and the selected parking space is minimized.

9. The device as recited in claim 8, wherein the first determining device includes a vehicle sensor for determining an occupancy state of a parking space.

10. The device as recited in claim 8, wherein a vehicle sensor is assigned to each of a number of parking spaces of the parking facility.
